(19) United States
(12) Patent Application Publication
(10) Pub. No.: US 2012/0139890 A1
(43) Pub. Date: Jun. 7, 2012

(54) Organic light emitting display device

(76) Inventor: Sang-Moo Choi, Yongin-City (KR)

(21) Appl. No.: 13/137,495

(22) Filed: Aug. 22, 2011

(30) Foreign Application Priority Data
Dec. 6, 2010 (KR) 10-2010-0123437

(51) Int. Cl. G06F 3/038; G09G 3/30

(52) U.S. Cl. 345/212; 345/76

(57) ABSTRACT

A display device includes a plurality of pixels connected with scan lines, emission control lines, and data lines; a plurality of switches connected between respective data lines and a data driver; a first power driver supplying an initial voltage for an initialization period, a reference voltage higher than the initial voltage for a compensation period, and a first high voltage higher than the reference voltage for a emission period, the first high voltage used as a first power supply; a second power driver supplying a second high voltage as a second power supply for the initialization period, the compensation period, and the charge period, and supplying a low voltage lower than the second high voltage for the emission period; a scan driver driving the scan lines and the emission control lines; and the data driver supplying data signals to the data lines for the charge period.

### BACKGROUND

1. Field

Embodiments relate to an organic light emitting display device. More particularly, an organic light emitting display device that can display an image with uniform luminance, regardless of the threshold voltage of a driving transistor.

2. Description of the Related Art

A variety of flat panel displays have been developed that make it possible to reduce the weight and the volume of cathode ray tubes. Typical flat panel displays are a liquid crystal display, a field emission display, a plasma display panel, an organic light emitting display device, etc.

The organic light emitting display device displays an image, using an organic light emitting diode. The organic light emitting diode produces light by recombining an electrode and a hole. The organic light emitting display device has the advantage of a high response speed and low power.

### SUMMARY

Embodiments provide an organic light emitting display device.

An organic light emitting display device that has one frame divided into an initialization period, a compensation period, a charge period, and an emission period, according to an embodiment, may include: a plurality of pixels connected with scan lines, emission control lines, and data lines; a plurality of switches connected between the data lines and a data driver; a first power driver supplying an initial voltage for the initialization period, a reference voltage higher than the initial voltage for the compensation period, and a first high voltage higher than the reference voltage for the emission period, the first high voltage used as a first power supply to power lines connected with the switches; a second power driver supplying a second high voltage as a second power supply for the initialization period, the compensation period, and the charge period, and supplying a low voltage lower than the second high voltage for the emission period; a scan driver driving the scan lines and the emission control lines; and a data driver supplying data signals to the data lines for the charge period.

The plurality of pixels may produce light with luminance corresponding to the data signal, while controlling the amount of current flowing from the first power supply to the second power supply for the emission period. The second high voltage may be set at a voltage where the plurality of pixels are set to a non-emission state. The scan driver may simultaneously supplies first scan signals to the scan lines for a portion of the later half of the initialization period and the compensation period, and may sequentially supplies second scan signals to the scan lines for the charge period. The first control signal may be set to have a width larger than the second scan signal. The scan driver may simultaneously supply emission control signals to the emission control lines for the charge period. The plurality of switches may connect the data lines with the power line for the initialization period, the compensation period, and the emission period, and the plurality of switches may connect the data lines with the data driver for the charge period.

The pixels may each include: an organic light emitting display device having a cathode electrode connected to the second power supply; a first transistor having a second electrode connected to an anode electrode of the organic light emitting diode, and controlling the amount of current supplied to the organic light emitting diode; a second transistor connected between a data line and a second node, and turned on when a scan signal is supplied to a scan line; a third transistor connected between a gate electrode and a second electrode of the first transistor, and turned on when a scan signal is supplied to the scan line; a fifth transistor connected between the second node and the data line and turned off when an emission control signal is supplied to an emission control line; and a storage capacitor connected between a gate electrode of the first transistor and the second node.

The organic light emitting display device may further include a fourth transistor connected between the second node and the first electrode of the first transistor, and turned off when an emission control signal is supplied to the emission control line. The organic light emitting display device may further include a fourth transistor connected between the second electrode of the first transistor and the third transistor, and turned off when an emission control signal is supplied to the emission control line.

The scan driver may supply scan signals to the scan lines for a portion of the later half of the initialization period, the compensation period, and the charge period. The scan driver may sequentially stop supplying the scan signals to the scan lines for the charge period. The scan driver may stop supplying a scan signal to the i-th scan line (i is a natural number), after a data signal corresponding to the i-th scan line is supplied, for the charge period.

The pixels may each include: an organic light emitting diode having a cathode electrode connected to the second power supply; a first transistor having a second electrode connected to an anode electrode of the organic light emitting diode, and controlling the amount of current supplied to the organic light emitting diode; a storage capacitor connected between a data line and a gate electrode of the first transistor; a fourth transistor connected between a first electrode of the first transistor and the data line, and turned off when an emission control signal is supplied to an emission control line; and a third transistor connected between a gate electrode and a second electrode of the first transistor, and turned on when a scan signal is supplied to a scan line.

### BRIEF DESCRIPTION OF THE DRAWINGS

The accompanying drawings, together with the specification, illustrate exemplary embodiments of the inventive concept, and, together with the description, serve to explain the principles of the inventive concept:

FIG. 1 is a diagram illustrating an organic light emitting display device according to an embodiment.

FIG. 2 is a circuit diagram illustrating a pixel according to a first embodiment.

FIG. 3 is a waveform diagram illustrating a method of driving the pixel shown in FIG. 2.

FIG. 4 is a circuit diagram illustrating a pixel according to a second embodiment.

FIG. 5 is a circuit diagram illustrating a pixel according to a third embodiment.

FIG. 6 is a waveform diagram illustrating a method of driving the pixel shown in FIG. 5.

FIG. 7 is a circuit diagram illustrating a pixel of the related art.

### DETAILED DESCRIPTION

Korean Patent Application No. 10-2010-0123437, filed on Dec. 6, 2010, in the Korean Intellectual Property Office, and entitled: “Organic Light Emitting Display Device” is incorporated by reference herein in its entirety.

The inventive concept will now be described more fully hereinafter with reference to the accompanying drawings, in which exemplary embodiments of the inventive concept are illustrated. The inventive concept may, however, be embodied in different forms and should not be construed as limited to the embodiments set forth herein. Rather, these embodiments are provided so that this disclosure will be thorough and complete, and will fully convey the scope of the inventive concept to those skill in the art.

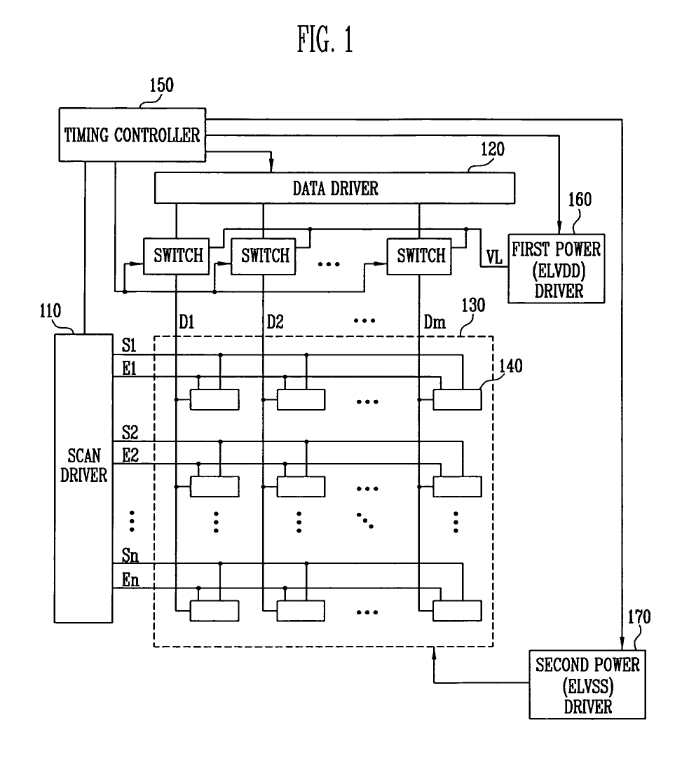

Preferred embodiments for those skilled in the art are described hereafter in detail with reference to FIGS. 1-6.

FIG. 1 is a diagram illustrating an organic light emitting display device according to an embodiment.

Referring to FIG. 1, an organic light emitting display device according to an embodiment includes: a pixel unit 130 including pixels 140 disposed at the intersections of scan lines S1 to Sn and data lines D1 to Dm, a scan driver 110 that drives the scan lines S1 to Sn, and emission control lines E1 to En, a data driver 120 that drives the data lines D1 to Dm, a first power driver 160 that supplies first power ELVDD to a power line VL, a second power driver 170 that supplies second power ELVSS to the pixels 140, switches 180 that are disposed in the data lines D1 to Dm and connect the data lines D1 to Dm to the data driver 120 or the power line VL, and a timing controller 150 that controls the drivers 110, 120, 160, and 170.

The first power driver 160 supplies first voltage ELVDD that changes to initial voltage Vint, reference voltage Vref, and first high voltage Vhigh1 to the power line VL. The first power driver 160, as shown in FIG. 4, supplies the initial voltage Vint for an initialization period, the reference voltage Vref, higher than the initial voltage Vint, for a compensation period, and the first high voltage Vhigh1, higher than the reference voltage Vref, for an emission period, in one frame, to the power line VL. In this configuration, the initial voltage Vint is set at sufficiently low voltage such that the organic light emitting diode OLED is set in a non-emission state and the first high voltage Vhigh1 is set at sufficiently high voltage such that the organic light emitting diode OLED is set in an emission state.

The scan driver 110 supplies first scan signals and second scan signals to the scan lines S1 to Sn. In this configuration, the first scan signals are simultaneously supplied to the scan lines S1 to Sn for the later half of the initialization period. The compensation period and the second scan signals are sequentially supplied to the scan lines S1 to Sn for a charge period. The scan driver 110 simultaneously supplied emission control signals to the emission control lines E1 to En for the charge period. The first scan signal has a large width than the second scan signal, such that the threshold voltage of a driving transistor can be stably compensated.

The data driver 120 supplies data signals to the data lines D1 to Dm in synchronization with the second scan signals supplied to the scan lines S1 to Sn.

The second power driver 170 supplies second high voltage Vhigh, as a second power supply ELVSS. Therefore, the pixels 140 can be set in a non-emission state for the initialization period, the compensation period, and the charge period. The pixels 140 supply low voltage Vlow for the other periods. In this configuration, the second high voltage Vhigh2 is a voltage where the pixels 140 can be set in the non-emission state (e.g. the same voltage as the first high voltage Vhigh1) and the low voltage Vlow is a voltage where the pixels 140 can be set in the emission state (e.g. the same voltage as the initial voltage Vint).

In response to synchronization signals supplied from the outside, the timing control unit 150 controls the scan driver 110, the data driver 120, the first power driver 160, and the second power driver 170.

The switches 180 are connected to the data lines D1 to Dm, respectively. The switches 180 connect the data lines D1 to Dm to the data driver 120 for the charge period by the control of the timing controller 150. The switches connect the data lines D1 to Dm to the power line VL for the other periods.

The pixel 140 initializes an anode electrode of the organic light emitting diode (OLED) to the initial voltage Vint and compensates the threshold voltage of the driving transistor for the compensation period. The pixel 140 is charged with voltage corresponding to a data signal for the charge period. While supplying current corresponding to the charged voltage to the organic light emitting diode (OLED) for the emission period, the pixel 140 produces light with predetermined luminance.

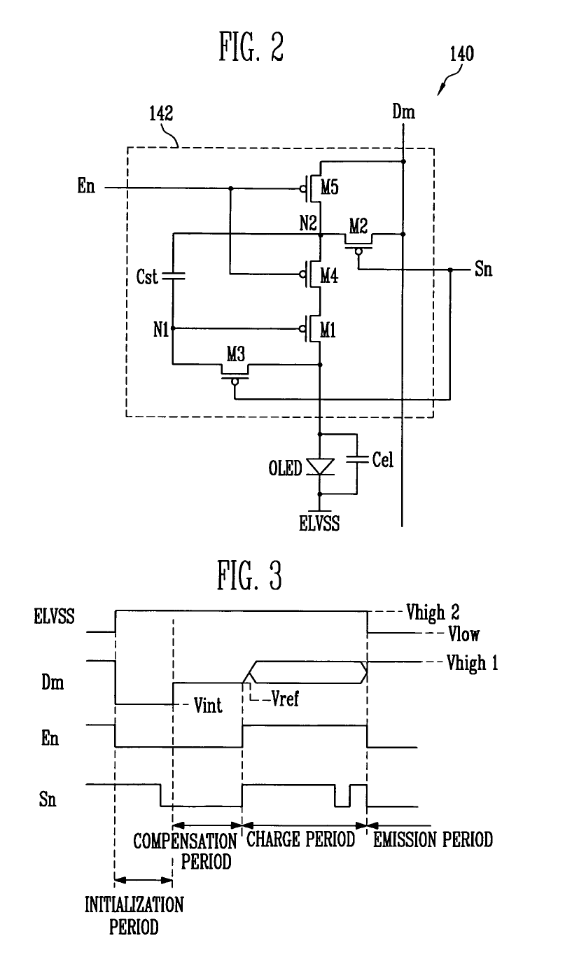

FIG. 2 is a diagram illustrating a pixel according to a first embodiment. The pixel connected with the n-th scan line Sn and the m-th data line Dm, is shown in FIG. 2.

Referring to FIG. 2, the pixel 140, according to an embodiment includes: an organic light emitting diode (OLED) and a pixel circuit 142 connected to the data line Dm and the scan line Sn. The pixel circuit 142 controls the amount of current supplied to the organic light emitting diode (OLED).

The anode electrode of the organic light emitting diode (OLED) is connected to the pixel circuit 142. The cathode electrode is connected to a second power supply ELVSS. In response to the amount of current supplied from the pixel circuit 142, the organic light emitting diode (OLED) produces light with predetermined luminance.

When a scan signal is supplied to the scan line Sn, the pixel circuit 142 receives a data signal through the data line Dm and controls the current flowing from the first power supply ELVDD, at the first high voltage Vhigh1, to the second power supply ELVSS, at the low voltage Vlow. The current is controlled for the emission period through the organic light emitting diode (OLED). For this operation, the pixel circuit 142 includes first to fifth transistors M1 to M5 and a storage capacitor Cst.

The storage capacitor Cst is connected between a first node N1 and a second node N2. The storage capacitor Cst is charged with voltage corresponding to a data signal and threshold voltage of the first transistor M1 (driving transistor).

A first electrode of the first transistor M1 is connected to a second electrode of the fourth transistor M4 and a second electrode is connected to the anode electrode of the organic light emitting diode (OLED). A gate electrode of the first transistor M1 is connected to the first node N1. The first transistor M1 controls the amount of current supplied to the organic light emitting diode (OLED) in response to the voltage applied to the first node N1.

A first electrode of the second transistor M2 is connected to the data line Dm and a second electrode is connected to the second node N2. A gate electrode of the second transistor M2 is connected to the scan line Sn. When the first scan signal and the second scan signal are supplied to the scan line Sn, the second transistor M2 is turned on and electrically connects the data line Dm with the second node N2.

A first electrode of the third transistor M3 is connected to a second electrode of the first transistor M1. A second electrode is connected to the first node N1. A gate electrode of the third transistor M3 is connected to the scan line Sn. When the first scan signal and the second scan signal are supplied to the scan line Sn, the third transistor M3 is turned on and connects the first transistor M1 in a diode type.

A first electrode of the fourth transistor M4 is connected to the second node N2. The second electrode is connected to the first electrode of the first transistor M1. A gate electrode of the fourth transistor M4 is connected to the emission control line En. The fourth transistor M4 is turned off, when an emission control signal is supplied to the emission control line En. The fourth transistor M4 is turned on when an emission control signal is not supplied.

A first electrode of the fifth transistor M5 is connected to the data line Dm and a second electrode is connected to the second node N2. The gate electrode of the fifth transistor M5 is connected to an emission control line En. The fifth transistor M5 is turned off, when an emission control signal is supplied to the emission control line En. The fifth transistor M5 is turned on when an emission control signal is not supplied.

The capacitor Cel, shown in FIG. 2, implies a parasitic capacitor of the organic light emitting diode OLED. The parasitic capacitor Cel has a larger capacitance than the storage capacitor Cst.

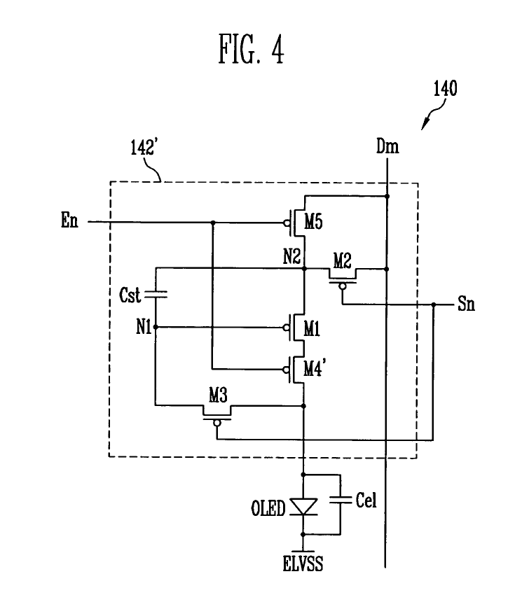

FIG. 3 is a waveform diagram illustrating a method of driving the pixel shown in FIG. 2. The switches 180 connect the data lines D1 to Dm to the power line VL for the initialization period, the compensation period, and the emission period. The switches 180 connect the data lines D1 to Dm to the data driver 120 for the charge period.

Referring to FIG. 3, the second high voltage Vhigh2 is supplied as the second power ELVSS for the initialization period, the compensation period, and the charge period. The low voltage Vlow is supplied for the emission period. Where the second high voltage Vhigh2 is supplied as the second power ELVSS, the pixels 140 are set in the non-emission state, for the initialization period, the compensation period, and the charge period.

The initial voltage Vint is supplied to the power line VL for the initialization period. The initial voltage Vint supplied to the power line VL is supplied to the data liens D1 to Dm through the switches 180. In this process, since the fourth transistor M4 and the fifth transistor M5 are turned off for the initialization period, the initial voltage Vint is supplied to the first electrode of the first transistor M1. Thus, the anode electrode of the organic light emitting diode (OLED) drops to the initial voltage Vint. The parasitic capacitor Cel is charged with the initial voltage Vint.

The first scan signals are supplied to the scan lines S1 to Sn for the later half of the initialization period and the compensation period, after the parasitic capacitor Cel is charged with the initial voltage Vint. The reference voltage Vref is supplied to the data lines D1 to Dm through the power line VL and the switches 180 for the compensation period.

As the first scan signal is supplied to the scan line Sn, the third transistor M3 and the second transistor M2 are turned on. As the third transistor M3 is turned on, the first node N1 and the anode electrode of the organic light emitting diode (OLED) are electrically connected. In this state, the voltage of the first node N1 drops approximately to the initial voltage Vint, corresponding to the voltage stored in the parasitic capacitor Cel.

When the second transistor M2 is turned on, the reference voltage Vref from the data line Dm is supplied to first electrode of the first transistor M1 through the second node N2. Accordingly, the voltage of the first node N1 increases from the initial voltage Vint up to voltage Vref-|Vth|. Voltage Vref-|Vth| is obtained by subtracting the threshold voltage of the first transistor from the reference voltage Vref.

The second scan signals are sequentially supplied to the scan lines S1 to Sn for the charge period. Data signals are supplied to the data lines D1 to Dm in synchronization with the second scan signals. Emission control signals are supplied to the emission control lines E1 to En for the charge period. During this charge period, the fourth transistor M4 and the fifth transistor M5 are turned off. Since the fourth transistor M4 is turned off, the second node N2 and the first transistor M1 are electrically disconnected. When the fifth transistor M5 is turned off, the data line Dm and the second node N2 are electrically disconnected.

As the second scan signal is supplied to the scan line Sn, the second transistor M2 and the third transistor M3 are turned on. When the second transistor M2 is turned on, the second node N2 and the data line Dm are electrically connected. In this state, a data signal from the data line Dm is supplied to the second node N2. Accordingly, the voltage of the second node N2 changes from the reference voltage Vref to the voltage of the data signal.

Since the third transistor M3 is turned on, the first node N1 is electrically connected with the parasitic capacitor Cel. Due to the change in voltage of the second node N2, the voltage of the first node N1 changes, and corresponds to the ratio of the storage capacitor Cst and the parasitic capacitor Cel. Therefore, the storage capacitor Cst is charged with the voltage expressed by Formula 1 below:

$$Cst ( V ) = \frac{Cst}{( Cst + Cel )} \times ( Vdata - Vref ) + Vref - \vert Vth \vert \qquad [ Formula 1 ]$$

In Formula 1, CSt(V) is the voltage charged in the storage capacitor Cst and Vdata is the voltage of a data signal, and Vth is the threshold voltage of the first transistor M1.

The second power supply ELVSS is set at the low voltage Vlow. The first high voltage Vhigh1 is supplied to the power line VL for the emission period. An emission control signal will stop being supplied for the emission period. Thus, the fourth transistor M4 and the fifth transistor M5 are turned on.

When the fourth transistor M4 and the fifth transistor M5 are turned on, the data line Dm and the first electrode of the first transistor M1 are electrically connected. In this state, since the first node N1 is set in a floating state, the storage capacitor Cst keeps the voltage stored for the charge period.

In response to the voltage stored in the storage capacitor Cst, for the emission, period, the first transistor M1 controls the amount of current flowing from the first high voltage Vhigh (i.e. ELVDD) to the low voltage Vlow (i.e. ELVSS) through the organic light emitting diode (OLED).

The present embodiments described above have the advantage of being able to compensate the threshold voltage of the driving transistor M1, using the pixel circuit 142. The pixel circuit 142 includes five transistors M1 to M5 and one capacitor Cst.

According to the present embodiment, it is possible to remove non-uniformity of an image. Removing non-uniformity can occur because an off-bias voltage is applied to the first transistor M1 for an initialization period. To be more specific, when an off-bias voltage is not applied to the first transistor M1, luminance increases in a staircase waveform as white gradation is implemented from black. However, in the present embodiments, it is possible to display an image with desired luminance without non-uniformity by applying an off-bias voltage to the first transistor M1 for the initialization period.

As expressed by Formula 1, the voltage stored in the storage capacitor Cst is determined, regardless of the first power ELVDD. Therefore, it is possible to display an image with desired luminance, regardless of the voltage drop of the first power supply ELVDD in the present embodiments. The present embodiments have the advantage of being able to compensate the threshold voltage of the first transistor M1 for a sufficient time by controlling the compensation period where the control signal and the reference voltage Vref are supplied.

FIG. 4 is a diagram illustrating a pixel according to a second embodiment. In explaining FIG. 4, the same components as in FIG. 2 are designated by the same reference numerals and the detailed description is not provided.

Referring to FIG. 4, a fourth transistor M4′ in a pixel circuit 142′, according to the second embodiment is connected between the first transistor M1 and the third transistor M3. A first electrode of the fourth transistor M4′ is connected to the second electrode of the first transistor M1 and a second electrode is connected to the first electrode of the third transistor M3. A gate electrode of the fourth transistor M4′ is connected to the emission control line En. The fourth transistor M4′ is turned off when an emission control signal is supplied to the emission control line En. The fourth transistor M4′ is turned on and controls the connection between the first transistor M1 and the third transistor M3.

The pixel, according to the second embodiment, has the same operation as the pixel according to the first embodiment in FIG. 2, with the exception that the position of the fourth transistor M4′ changes. Therefore, the detailed description is not provided.

FIG. 5 is a diagram illustrating a pixel according to a third embodiment. In explaining FIG. 5, the same components as in FIG. 2 are designated by the same reference numerals and the detailed description is not provided.

Referring to FIG. 5, the data line Dm is directly connected to the second node N2 in a pixel circuit 142″ according to the third embodiment. The second transistor M2 and the fifth transistor M5 shown in FIG. 2 are removed in the pixel circuit 142″ according to the third embodiment.

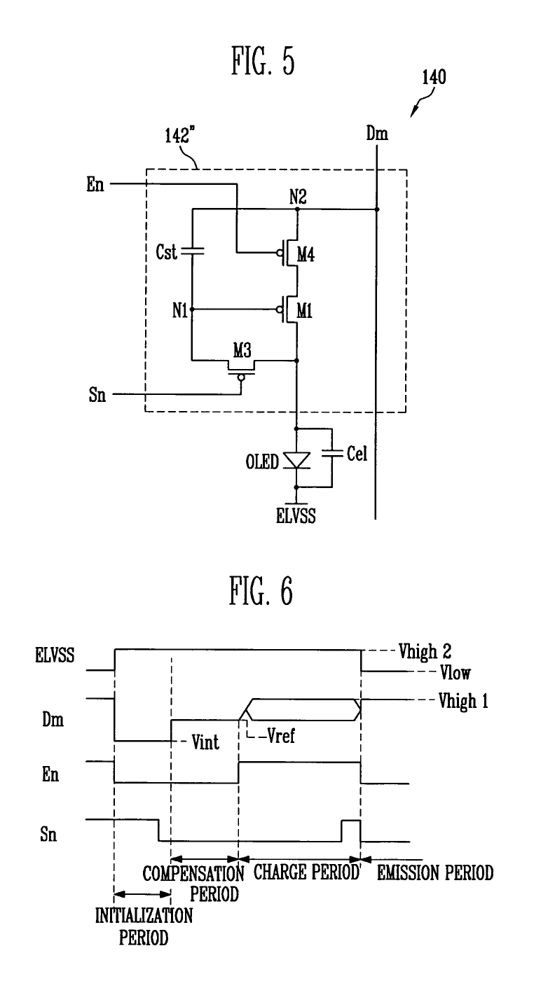

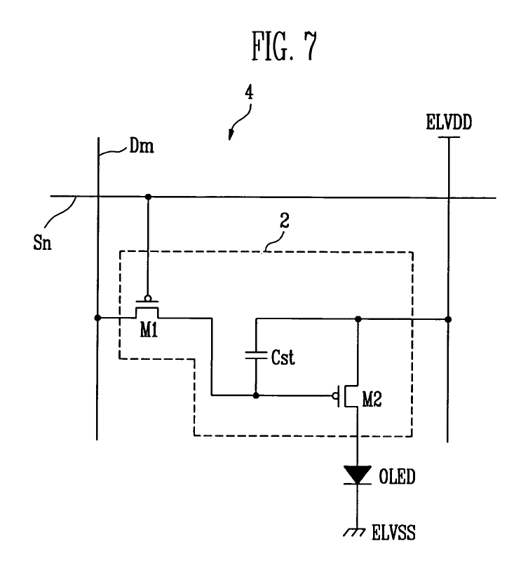

As shown in FIG. 6, where a desired data signal is supplied from the compensation period, the third transistor M3 stays turned on for the charge period. The third transistor M3 in the pixels 140 stays turned on for the compensation period and is sequentially turned off for each horizontal line for the charge period.

The other circuit configuration is the same as that of the pixel according to the first embodiment. Thus, the detailed description is not provided.

FIG. 6 is a waveform diagram illustrating a method of driving the pixel shown in FIG. 5.

Referring to FIG. 6, the second power ELVSS at the second high voltage Vhigh2 is supplied. The pixel 140 is set in the non-emission state, for the initialization period, the compensation period, and the charge period, while the second power ELVSS at the low voltage Vlow is supplied. The pixel 140 is set in the emission state for the emission period.

For the initialization period, the initial voltage Vint is supplied to the data line Dm through the power line VL and the switch 180. Since the fourth transistor M4 stays turned on for the initialization period, the initial voltage Vint supplied to the data line Dm is supplied to the first electrode of the first transistor M1 through the second node N2. Therefore, the anode electrode of the organic light emitting diode OLED drops to the initial voltage Vint and the parasitic capacitor Cel is charged with the initial voltage Vint.

After the parasitic capacitor Cel is charged with the initial voltage Vint, the scan signals are supplied to the scan lines S1 to Sn for the later half of the initialization period and the compensation period. Furthermore, for the compensation period, the reference voltage Vref is supplied to the data lines D1 to Dm through the power line VL and the switches 180.

As the scan signal is supplied to the scan line Sn, the third transistor M3 is turned on. As the third transistor M3 is turned on, the first node N1 and the anode electrode of the organic light emitting diode (OLED) are electrically connected. Thus, corresponding to the voltage stored in the parasitic capacitor Cel, the voltage of the first node N1 drops approximately to the initial voltage Vint.

The reference voltage Vref, supplied to the data line Dm is supplied to the first electrode of the first transistor M1 through the second node N2. Accordingly, the voltage of the first node N1 increases from the initial voltage Vint up to the voltage Vref-|Vth|. The voltage Vref-|Vth| is obtained by subtracting the threshold voltage of the first transistor from the reference voltage Vref.

For the charge period, scan signals are sequentially stopped being supplied to the scan lines S1 to Sn. Emission control signals are supplied to the emission control lines E1 to En for the charge period. Thus, the fourth transistor M4 is turned off.

Data signals corresponding to the first horizontal line and the n-th horizontal line are sequentially supplied to the data line Dm. The data signal corresponding to the n-th horizontal line and supplied to the data line Dm is supplied to the second node N2. The voltage of the second node N2 changes from the initial reference voltage Vref to the voltage of the data signal.

Since the third transistor M3 stays turned on, the first node N1 is electrically connected with the parasitic capacitor Cel. The voltage of the first node N1 changes, due to the change in voltage of the second node N2, corresponding to the ratio of the storage capacitor Cst and the parasitic capacitor Cel. The storage capacitor Cst is charged with voltage expressed by Formula 1. A scan signal is stopped being supplied to the n-th scan line Sn after the storage capacitor Cst is charged at desired voltage. Thus, the third transistor M3 is turned off. As the third transistor M3 is turned off, the first node N2 has been set in the floating state, such that the storage capacitor keeps the voltage charged in the pervious period, regardless of a change in voltage of the second node N2.

The voltage of the first node N1 changes in response to the data signal, even though the data signal corresponding to the first horizontal line and the n−1-th horizontal line is supplied to the data line Dm. The voltage of the first node N1 is finally determined by the data signal corresponding to the n-th horizontal line. Accordingly, the storage capacitor Cst can be charged at a desired voltage.

For the emission period, the second power supply ELVSS is set at the low voltage Vlow and the first high voltage Vhigh1 is supplied to the power line VL. As an emission control signal is stopped from being supplied for the emission period, the fourth transistor M4 is turned on.

When the fourth transistor M4 is turned on, the data line Dm and the first electrode of the first transistor M1 are electrically connected. Therefore, in response to the voltage applied to the first node N1, the first transistor M1 controls the amount of current flowing from the first high voltage Vhigh1 to the low voltage Vlow through the organic light emitting diode (OLED).

FIG. 7 is a circuit diagram illustrating a pixel of an organic light emitting display device in the conventional art.

Referring to FIG. 7, a pixel 4 of an organic light emitting display device of the conventional art includes: an organic light emitting diode (OLED); and a pixel circuit 2, connected with a data line Dm and a scan line Sn. The pixel circuit 2 controls the organic light emitting diode (OLED).

The anode electrode of the organic light emitting diode (OLED) of the conventional art is connected to the pixel circuit. The cathode electrode is connected to a second power supply ELVSS. The organic light emitting diode OLED produces light with predetermined luminance in response to the current supplied from the pixel circuit 2.

When a scan signal is supplied to the scan line Sn, in response to a data signal supplied to the data line Dm, the pixel circuit 2 controls the amount of current supplied to the organic light emitting diode (OLED) of the conventional art. For this configuration, the pixel circuit 2 includes: a second transistor M2 connected between a first power supply ELVDD and the organic light emitting diode OLED, a first transistor M1 connected between the second transistor M2, the data line Dm, and the scan line Sn, and a storage capacitor Cst connected between a gate electrode and a first electrode of the second transistor M2.

In the conventional art, a gate electrode of the first transistor M1 is connected to the scan line Sn. A first electrode is connected to the data line Dm. A second electrode of the first transistor M1 is connected to one terminal of the storage capacitor Cst. In this configuration, the first electrode is set as any one of a source electrode and a drain electrode. The second electrode is set as the other electrode, different from the first electrode. For example, when the first electrode is set as the source electrode, the second electrode is set as the drain electrode. The first transistor M1, connected to the scan line Sn and the data line Dm, is turned on and supplies a data signal to the storage capacitor Cst. When a scan signal is supplied through the scan line Sn, the data signal is supplied through the data line Dm. In this operation, the storage capacitor Cst is charged with voltage corresponding to the data signal.

In the conventional art, the gate electrode of the second transistor M2 is connected to one terminal of the storage capacitor Cst. The first electrode is connected to the first power supply ELVDD and the other terminal of the storage capacitor Cst. The second electrode of the second transistor M2 is connected to the anode electrode of the organic light emitting diode OLED. In response to the voltage value stored in the storage capacitor Cst, the second transistor M2 controls the amount of current flowing from the first power supply ELVDD to the second power supply ELVSS through the organic light emitting diode OLED. The organic light emitting diode OLED produces light corresponding to the amount of current supplied from the second transistor M2.

However, the pixel 4 of the organic light emitting display device of the conventional art cannot display an image with uniform luminance. In other words, due to process variation, the second transistors M2 (driving transistors) in the pixels 4 have different threshold voltages for each pixel 4. As the threshold voltages of the driving transistors are different, light with different luminance is generated by the difference in the threshold voltage of the driving transistors. This occurs even if data signals corresponding to the same gradation are supplied to the pixels 4.

In order to overcome the problems of the conventional art, a structure with a transistor in each pixel 4 to compensate the threshold voltage of the driving transistor has been proposed. A structure using six transistors and one capacitor for each pixel 4 to compensate the threshold voltage of a driving transistor has been disclosed (Korean Patent Publication No. 2007-0083072). However, the six transistors included in that configuration of pixel 4 creates complications. The possibility of malfunction is increased by the transistors in the pixels 4. In addition, the yield is correspondingly decreased.

In contrast, the present embodiments provide an organic light emitting display device, having a simple structure, to compensate the threshold voltage of a driving transistor.

According to an organic light emitting display device of an embodiment, it is possible to compensate the threshold voltage of a driving transistor and voltage drop of first power. Thus, using a relatively simple pixel circuit, and an image may be displayed with desired luminance. Furthermore, according to the present embodiments, it is possible to ensure compensation of the threshold voltage of the driving transistor for a long time. According to the present embodiments, there is no problem of non-uniformity in luminance. Non-uniformity is not a problem because a bias voltage is applied to the driving transistor for an initializing period.

Exemplary embodiments of the inventive concept have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the inventive concept as set forth in the following claims.

What is claimed is:

1. An organic light emitting display device that has one frame divided into an initialization period, a compensation period, a charge period, and an emission period, the organic light emitting display device comprising:
a plurality of pixels connected with scan lines, emission control lines, and data lines;
a plurality of switches connected between respective data lines and a data driver;
a first power driver supplying an initial voltage for the initialization period,
a reference voltage higher than the initial voltage for the compensation period, and
a first high voltage higher than the reference voltage for the emission period, the first higher voltage used as a first power supply to power lines connected with the switches;
a second power driver supplying a second high voltage as a second power supply for the initialization period, the compensation period, and the charge period, and supplying a low voltage lower than the second high voltage for the emission period;
a scan driver driving the scan lines and the emission control lines; and
the data driver supplying data signals to the data lines for the charge period.

2. The organic light emitting display device as claimed in claim 1, wherein:
the plurality of pixels produce light with luminance corresponding to the data signal, while controlling the amount of current flowing from the first power supply to the second power supply for the emission period.

3. The organic light emitting display device as claimed in claim 2, wherein:
the second high voltage is set at a voltage where the plurality of pixels are set to a non-emission state.

4. The organic light emitting display device as claimed in claim 1, wherein:
the scan driver simultaneously supplies first scan signals to the scan lines for a portion of the later half of the initialization period and the compensation period, and sequentially supplies second scan signals to the scan lines for the charge period.

5. The organic light emitting display device as claimed in claim 4, wherein:
the first scan signal is set to have a width larger than the second scan signal.

6. The organic light emitting display device as claimed in 1, wherein:
the scan driver simultaneously supplies emission control signals to the emission control lines for the charge period.

7. The organic light emitting display device as claimed in claim 1, wherein:
the plurality of switches connect respective data lines with the power line for the initialization period, the compensation period, and the emission period, and
the plurality of switches connect respective data lines with the data driver for the charge period.

8. The organic light emitting display device as claimed in claim 4, the pixels comprising:
an organic light emitting display device having a cathode electrode connected to the second power supply;
a first transistor having a second electrode connected to an anode electrode of the organic light emitting diode, and controlling the amount of current supplied to the organic light emitting diode;
a second transistor connected between a data line and a second node, and turned on when a scan signal is supplied to a scan line;
a third transistor connected between a gate electrode and a second electrode of the first transistor, and turned on when a scan signal is supplied to the scan line;
a fifth transistor connected between the second node and the data line, and turned off when an emission control signal is supplied to an emission control line; and
a storage capacitor connected between a gate electrode of the first transistor and the second node.

9. The organic light emitting display device as claimed in claim 8, further comprising:
a fourth transistor connected between the second node and the first electrode of the first transistor, and turned off when an emission control signal is supplied to the emission control line.

10. The organic light emitting display device as claimed in claim 8, further comprising:
a fourth transistor connected between the second electrode of the first transistor and the third transistor, and turned off when an emission control signal is supplied to the emission control line.

11. The organic light emitting display device as claimed in claim 1, wherein:
the scan driver supplies scan signals to the scan lines for a portion of the later half of the initialization period, the compensation period, and the charge period.

12. The organic light emitting display device according to claim 11, wherein:
the scan driver sequentially stops supplying the scan signals to the scan lines for the charge period.

13. The organic light emitting display device as claimed in claim 12, wherein:
the scan driver stops supplying a scan signal to the i-th scan line (i is a natural number), after a data signal corresponding to the i-th scan line is supplied, for the charge period.

14. The organic light emitting display device as claimed in claim 12, wherein each pixel of the plurality of pixels includes:
an organic light emitting diode having a cathode electrode connected to the second power supply;
a first transistor having a second electrode connected to an anode electrode of the organic light emitting diode, and controlling the amount of current supplied to the organic light emitting diode;
a storage capacitor connected between a data line and a gate electrode of the first transistor;
a fourth transistor connected between a first electrode of the first transistor and the data line, and turned off when an emission control signal is supplied to an emission control line; and
a third transistor connected between a gate electrode and a second electrode of the first transistor, and turned on when a scan signal is supplied to a scan line.
